(19) United States
(12) Patent Application Publication
(10) Pub. No.: US 2012/0143959 A1
(43) Pub. Date: Jun. 7, 2012

(54) Method for Delivering Email for Viewing on a Mobile Communication Device

(76) Inventor: James Qingdong Wang, Duluth, GA (US)

(21) Appl. No.: 12/872,247

(22) Filed: Aug. 31, 2010

(51) Int. Cl. G06F 15/16

(52) U.S. Cl. 709/206

(57) ABSTRACT

A process of delivering an E-mail contents from a server to a mobile device based on E-mail mailbox profile, comprising building a graph structure in the server representing a map of the mailbox, initializing an entry for the sender's address of an email in the profile, transmitting email read flag update from the mobile device to the server, updating the profile entry based on read flag of incoming E-mails and sending E-mail contents to the mobile device based on the profile entry setting.

### FIELD OF THE INVENTION

The following is to define a method of conveniently displaying contents on mobile communication device, and more particularly a method of dynamically displaying email contents without having to retrieve full email body onto the device based on user preference.

### BACKGROUND OF THE INVENTION

Mobile communication devices are increasingly popular for personal use due to more and more features and applications available on those devices, which enable people being connected with friends. Handheld mobile communication devices, sometimes referred to as mobile stations, are essentially portable computers with wireless capability, and come in various forms. These include Personal Digital Assistants (PDAs), cellular phones and smart phones. One of the most useful ones is Electronic mail (Email) application. While it is very convenient of having access to those emails from a mobile communication device, bandwidth and processing constraints of such devices present challenge to the downloading and viewing of emails.

People receive emails from different sources, including family members, friends and various Internet-based social communities etc, in vast volume. While emails from family members and friends are certainly important and people would like to read them once they receive them, people often skip commercial emails. Email can be in various forms. Plain-text based email is simple and small in size while HTML based email can be very complex, containing a rich set of multi-media contents, and usually large in size.

The downloading of an entire email, including multi-media based contents, to a mobile device consumes a large amount of bandwidth, especially when the email is very large. In addition, viewing even a small portion of such an email on device consumes substantial device resources, such as CPU, memory, battery and storage.

### SUMMARY OF THE INVENTION

According to an aspect of the invention, a method is provided for viewing header information or a portion of an email on a mobile communication device without having to retrieve the full email contents onto the device. In one embodiment, a server learning function is used for delivering the sender address and subject of an email to a mobile communication device based on user profiles constructed at server. This allows the user to view only a small part of the email to determine if additional email content is required, and the user's email viewing experience is similar to that when using a desktop PC. More importantly, bandwidth usage and device power consumption are minimized by eliminating unnecessary email content transmission to the device.

Additional aspects and advantages will be apparent to a person of ordinary skill in the art, residing in the details of construction and operation as more fully hereinafter described and claimed, reference being had to the accompanying drawings.

### BRIEF DESCRIPTION OF THE DRAWINGS

A detailed description of this invention is set forth in details below, with reference to the following drawings:

FIG. 1 is a block diagram of a network where this invention may be applied;

FIG. 2 is a tree-based diagram showing the basic structure of Graph Object Module (GOM) representing a user's mailbox.

FIG. 3 shows the top-level of the GOM structure from FIG. 2.

FIG. 4 shows an example GOM structure for a user's mailbox.

FIG. 5 is a sequence diagram showing how email is delivered to mobile devices from server;

FIG. 6 is a flowchart showing how a user profile is constructed in server, based on user's action on emails.

### DETAILED DESCRIPTION OF THE PREFERRED EMBODIMENT

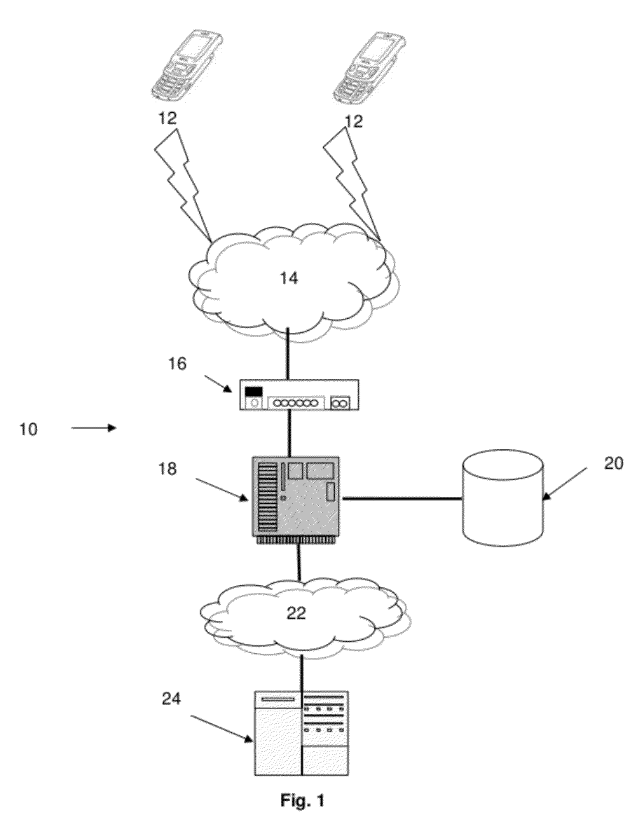

As illustrated in FIG. 1, network environment 10 is shown where this embodiment may be applied. Network environment 10 includes mobile devices 12 communicating through a wireless network 14 to an email service gateway server 18 for sending email to mobile devices 12. User's mailbox resides on mail servers 24 of different Internet Service Providers (ISPs). Database server 20 stores information about user's mailbox which email service gateway server 18 uses to retrieves emails, via the Internet 22, from mail servers 24. While only one email service gateway server and database server are shown in the diagram, people of skill in the art understands the network environment 10 may have multiple servers, so-called server farm, performing the same task. As people of skill in the art understands, wireless network 14 can be of many different types, including GPS/GPRS, CDMA, TDMA, iDEN Mobitex, EGDE, UMTS, W-CDMA or future networks such as LTE or WiMax and broadband networks like Bluetooth and variants of 802.11.

A connection from mobile device 12 to email service gateway server 18 requires permission on wireless network 14, which is authorized through wireless Network Access Point (NAP) 16.

Referred to throughout this document, for the purpose of describing the preferred embodiment, is the structure of a Graph based Object Model (GOM) for a mailbox information stored in database server 20.

The email service gateway server 18 uses a protocol-parsing interpreter in the preferred embodiment, for a specific mail type, to build a Graph based Object Model (GOM) structure representing a mailbox of that protocol. The mailbox GOM structure is stored in database server 20 and loaded in a memory cache of server 28, and can be iterated bi-directionally.

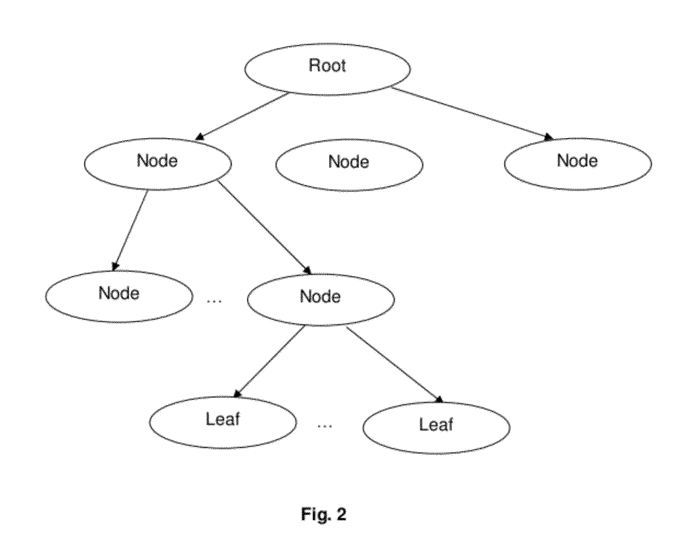

As demonstrated in FIG. 2, the graph-based mailbox GOM structure consists of nodes and leaves. The nodes are the parent of nodes and leaves. The leaves are the end of a branch in the graph. Each of the nodes and the leaves has a unique identifier, called a GOM ID, to identify itself in the mailbox GOM structure.

The mailbox GOM structure consists of three parts: top-level, mail components and mail references. The top-level refers to the mailbox root structure while the mailbox is constructed in mail components and mail references represent items referencing to some other internal mail components.

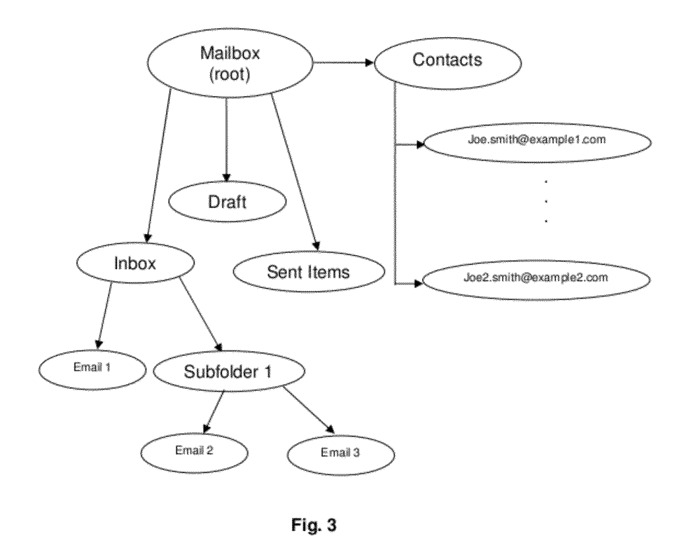

The root node of a mailbox GOM structure, referred as “Mailbox”, contains several children nodes. One of the children nodes is called “Profile”, containing profiles of email delivery for some email addresses which have sent emails to this mailbox. The rest children nodes, referred as “Folder”, represent the folder structure of the mailbox. Top-level folder nodes for a typical mailbox are “Inbox”, “Draft” and “Sent items”, containing received emails, drafted emails and sent emails respectively. Each folder node may contain subfolder nodes and email component, as shown in FIG. 3.

Email component consists of a hierarchy of fields. Each field represents a physical entity property, or a reference defined in an email. The physical entity fields are email subject, email date, email receiver address, email sender address, and email body fields. Email subject, date, receiver and sender address fields are collectively called email header information. The property fields for the email components are read status, reply status and importance status property fields. Two reference fields are defined for email component, email reference field which is used to reference other emails in the mailbox, and attachment reference field, which is used to reference the attachments in an email.

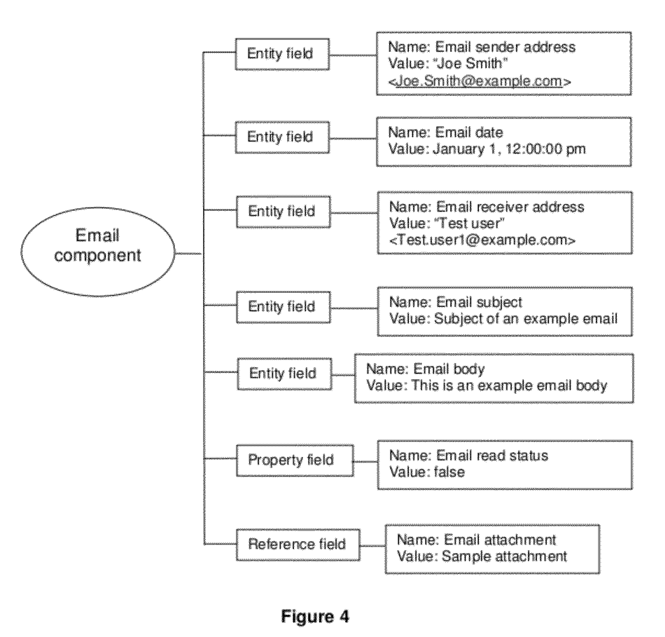

Using the following example email, the corresponding GOM structure is shown in FIG. 4.

From: “Joe Smith” <Joe.Smith@example.com>
Date: January 1, 12:00:00 pm
To: “Test user” <Test.user1@example.com>
Subject: Subject of an example email
This is an example email body
<<Sample attachment>>

As FIG. 4 shows, the email component consists of 5 entity fields, email sender, email date, email receiver, email subject and email body fields. It has one property field, read status field which is set to false, since it has not been read. In addition to that, the email component contains one attachment reference field, referring to the attachment in the email.

Having described the mailbox GOM structure used to implement an embodiment of the invention, a detailed description is provided of dynamically delivering email contents to mobile communication device based on user's profile according to the preferred embodiment.

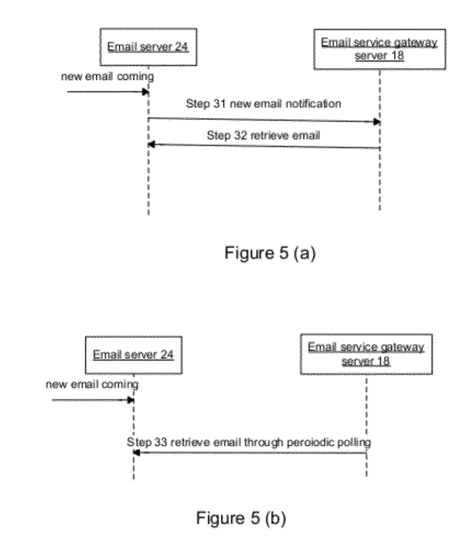

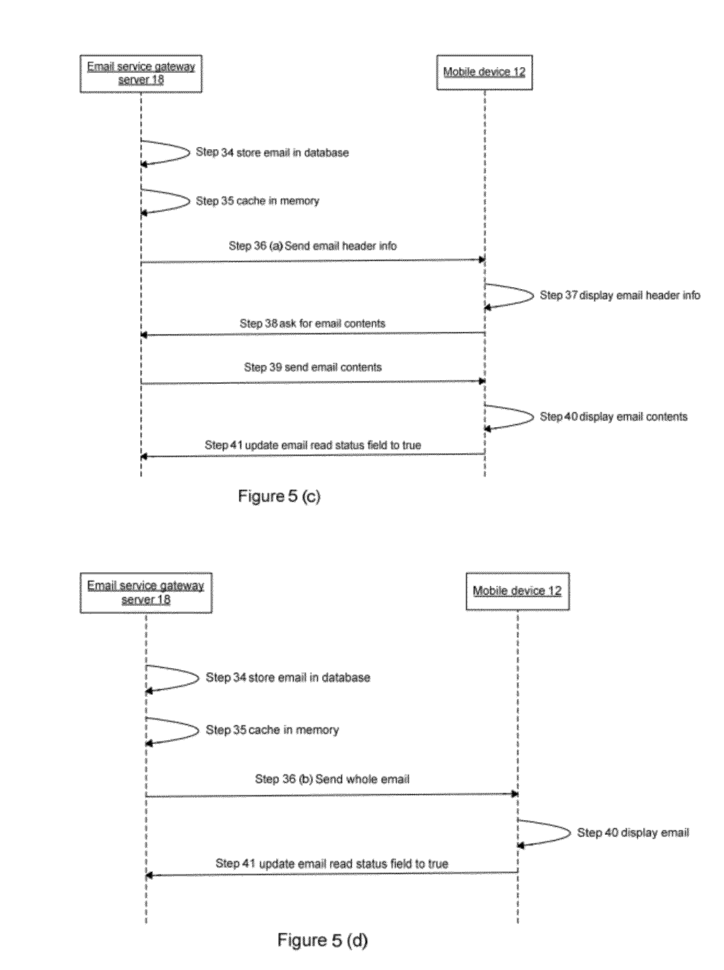

Dynamical delivery of email contents from email service gateway server to mobile communication device is a client and server operation. FIG. 5 shows the sequence of actions how emails from mail server 24 are delivered to mobile devices 12.

When there is a new email available for a mailbox on mail server, mail server notifies email service gateway server (step 31) about this through an already established notification channel. Email service gateway server retrieves the email (step 32) from the email server upon receiving the notification alert or email service gateway server fetches the email from the email server periodically (step 33). Once getting the email, the gateway server stores it in database server (step 34) and caches it in memory (step 35). It then pushes down the email header information only or whole email, based on the profile constructed over time for the mailbox, to mobile communication device (step 36). Client on mobile device displays the email header information to user (step 37). If user wants to read email contents after viewing the email header and email contents is not available, client sends a request for email contents (step 38) to email service gateway.

Upon receiving such a request, email service gateway sends the email contents of the email (step 39) back to the mobile device. Client on the device will display the email contents (step 40) to user upon receiving it. After user reads the email, client will send a request of updating email read status field to the server 20 (step 41).

Separately, when user deletes an email on mobile device, client sends a corresponding email deletion request to email service gateway server. The server will remove the email from database server after receiving the request.

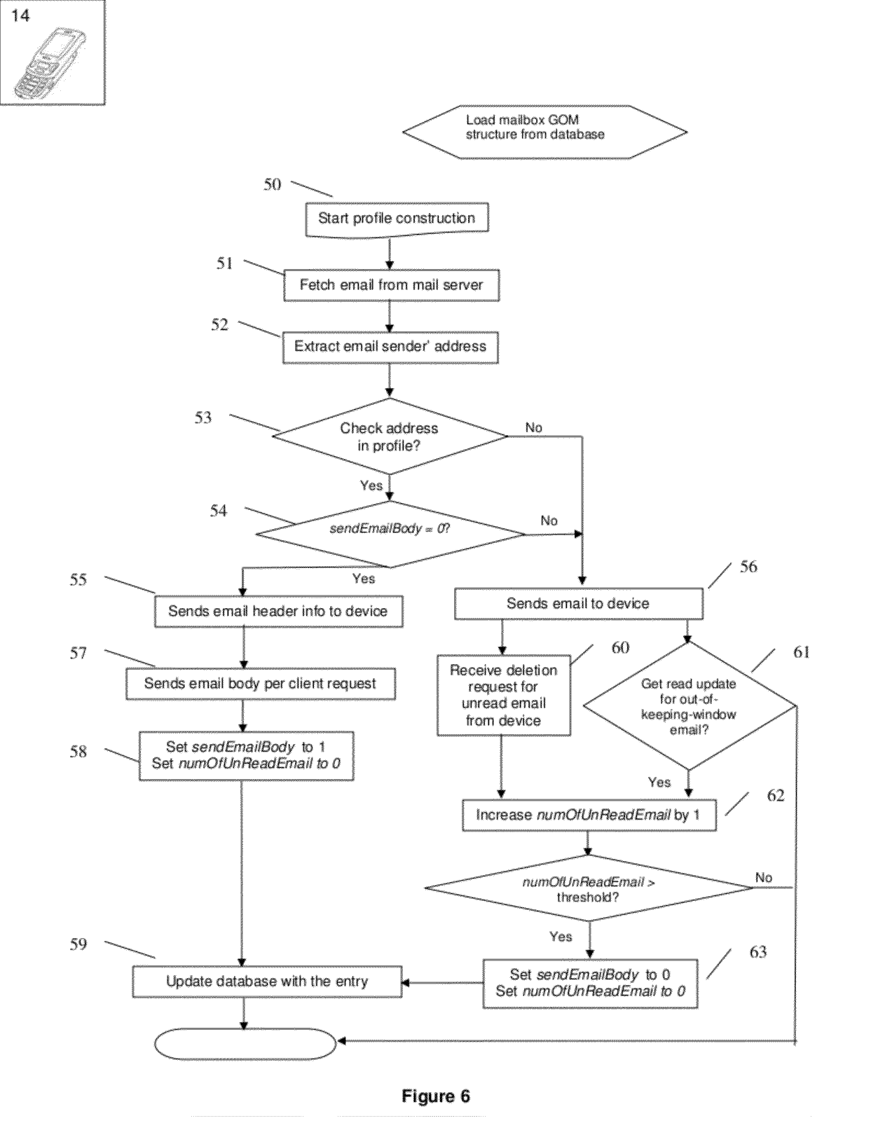

As described above, mailbox profile determines what part of an email gateway server sends down to device. FIG. 6 shows the processing steps of profile construction for a mailbox.

Mailbox profile is a map structure, which key is an email address and value entry is a structure of a Boolean value and an integer value. The Boolean indicates if the contents of an email from the key email address needs to be sent down to mobile device 12 and the integer value records the number of emails from the key email address which user has not been reading. The value entry has the following structure in syntax of C++ language

typedef struct
{

unsigned char sendEmailBody;
unsigned int numOfUnReadEmail;

} ProfileInfo;

This profile is an attribute of a mailbox, stored in database server 20 and loaded into the memory in the email service gateway server 18. After the server 18 fetches an email from email server 24, it starts the profile construction process (step 50).

Initially the profile map is empty for a newly created mailbox GOM on the server 18. When server 18 fetches email from mail server 20 (step 51), it gets the sender's email address (step 52) and checks if there is a value entry for the email address in the profile the map (step 53). If the entry exists and its member sendEmailBody is 0, the server 18 will send only the email header information to device (step 56), otherwise the server 18 will create an entry for the email address (step 54) if there is no associated entry and send down email header and email contents to device (step 57).

If only email header was sent down to device 12 and later client on the device requests email body (step 58), the server 18 will sends the email body to device (step 59), and update the profile by setting the variables sendEmailBody to 1 and reset the number of unread email (numOfUnReadEmail) for the entry (step 60). Server 18 will also update the entry contents in database server 20.

If whole email was sent down to device 12 and user deletes the email without reading it, server will update the entry by increasing the member numOfUnReadEmail by 1 (step 65) after receiving email deletion request from device (step 62). If numOfUnReadEmail is greater than a threshold predefined in the server 18 (step 66), server 18 will reset numOfUnReadEmail to 0 and set sendEmailBody to 0 (step 67), otherwise the server finish the process.

Sever 18 only keeps email for a period time, which is called email keeping window. When server 18 is about to remove email outside of keeping window (step 63), it check if device sends in read status update for the email (step 64). If the read status for the email is not updated, server 18 considers that user does not read the email and goes through step 65 to 67 and 61.

What is claimed is:

1. A process for transmitting an E-mail from a server to a mobile device based on the dynamically constructed profile of a user mailbox, comprising:
building a tree-based graph structure within said server representing a map of said mailbox;
extending said tree-based graph structure with incoming E-emails by extracting various fields, including sender's E-mail addresses and Read flags, from said incoming E-mails;
constructing said profile for said mailbox based on said sender's E-mail addresses of said incoming E-mails;
transmitting said E-mails with said Read flag being FALSE based on said profile to said mobile device;
transmitting Read flag change and user action for said E-mails from said mobile to said server indicative of how user handles said E-email;
updating said profile of said mailbox on said server based on said Read flag change and action.

2. The process of claim 1, wherein constructing said profile for said mailbox further comprises:
initializing profile by creating an empty map;
adding profile entry to said profile map for said E-mail address;
updating said profile entry based said E-mail read flag.

3. The process of claim 2, wherein said profile entry further comprises two entries:
boolean sendEmailBody, attribute to determine if body of said E-mail needs to be delivered to said mobile device;
integer numOfUnreadEmail, attribute to record the number of unread E-mails from said E-mail address since said attribute sendEmailBody is set to TRUE.

4. The process of claim 2, wherein updating said profile entry further comprises:
setting said attribute sendEmailBody to TRUE in said profile entry for said E-mail address in profile if said read flag is TRUE for an E-mail from said E-mail address;
increasing said attribute numOfUnreadEmail by 1 in said profile entry for said E-mail address in said profile if said E-mail read flag is FALSE; and in the event said attribute numOfUnreadEmail exceeds the said unread E-email number limit for said E-mail sender address, setting said attribute sendEmailBody to FALSE in said profile entry.

5. The process of claim 1, wherein building a tree-based graph for said E-mail mailbox further comprises:
constructing a node in said graph for each folder in said E-mailbox;
constructing a leaf under said node in said graph for each E-mail item in said folder.

6. The process of claim 1, wherein extending said tree-based graph structure with incoming E-emails further comprises:
constructing entity fields for said E-mail, including mail sender, email date, email receiver, email subject and email body field;
constructing property fields for said E-mail, including read flag.

7. The process of any one of claims 1 to 6, wherein said graph structure is a Graph Object Module (GOM).

8. A server process comprising:
building a tree-based graph representing a map of a E-mail mailbox;
creating a profile for said E-mail mailbox;
updating said profile based on property field read flag of incoming E-mails for said mailbox;
sending said E-mail to a mobile device based on said profile.

9. The process of claim 8, wherein updating said profile based on property field read flag further comprises:
increasing said attribute numOfUnreadEmail by 1 in said profile entry after E-email a deletion request for an E-mail is received from mobile device and said read flag of said E-mail is FALSE;
increasing said attribute numOfUnreadEmail by 1 in said profile entry after E-email is outside of the keeping period and said read flag for said E-mail has not been set to FALSE during said keeping period;
in the event said attribute numOfUnreadEmail exceeds the said unread E-email number limit for said E-mail sender address, setting said attribute sendEmailBody to FALSE in said profile entry;
Setting said attribute sendEmailBody to TRUE after update for said property field read flag is received from mobile device.

10. The process of claim 9 wherein keeping period is discussed further indicates:
said keeping period is configurable in system.

11. The process of claim 8 wherein sending said E-mail to a mobile device further comprises:
sending the header of said E-mail to mobile device if said attribute sendEmailBody is FALSE;
sending the header and body of said E-mail to mobile device if said attribute sendEmailBody is TRUE;

12. A mobile device process comprises:
transmitting E-mail deletion request to a server indicative of the deletion action on said E-mail on behalf of a user;
transmitting E-mail read flag update to said server indicative of the read action on said E-mail on behalf of said user;
